(19) United States
(12) Patent Application Publication
(10) Pub. No.: US 2023/0344558 A1
(43) Pub. Date: Oct. 26, 2023

(54) METHOD AND APPRATUS FOR TRANSMITTING AND RECEIVING HYBRID AUTOMATIC RETRANSMISSION REQUEST ACKNOWLEDGEMENT INFORMATION IN A WIRELESS COMMUNICATION SYSTEM

(71) Applicant: Samsung Electronics Co., Ltd., Suwon-si (KR)

(72) Inventors: Jingxing FU, Beijing (CN); Feifei SUN, Beijing (CN)

(21) Appl. No.: 18/297,471

(22) Filed: Apr. 7, 2023

(30) Foreign Application Priority Data
Apr. 21, 2022 (CN) 202210424281.8

(51) Int. Cl. H04L 1/1812; H04W 52/14; H04L 1/1867

(52) U.S. Cl. CPC H04L 1/1812; H04W 52/146; H04L 1/1896

(57) ABSTRACT

The disclosure relates to a fifth-generation (5G) or sixth-generation (6G) communication system for supporting a higher data transmission rate. A method and an apparatus for transmitting hybrid automatic retransmission request acknowledgement (HARQ-ACK) information are provided. A method performed by a user equipment (UE) in a wireless communication system is provided. The method includes determining HARQ-ACK information, determining transmission power of an uplink channel for transmitting the HARQ-ACK information, and transmitting the uplink channel according to the transmission power.

### CROSS-REFERENCE TO RELATED APPLICATION(S)

This application is based on and claims priority under 35 U.S.C. § 119(a) of a Chinese patent application number 202210424281.8, filed on Apr. 21, 2022, in the Chinese Intellectual Property Office, the disclosure of which is incorporated by reference herein in its entirety.

### BACKGROUND

### 1. Field

The disclosure relates to a wireless communication system (or wireless networks) or a mobile communication system (or, mobile networks). More particularly, the disclosure relates to a method and an apparatus for transmission of hybrid automatic retransmission request acknowledgement (HARQ-ACK) feedback information in a wireless communication system.

### 2. Description of Related Art

Fifth-generation (5G) mobile communication technologies define broad frequency bands such that high transmission rates and new services are possible, and can be implemented not only in “Sub 6 giga hertz (GHz)” bands such as 3.5 GHz, but also in “Above 6 GHz” bands referred to as mmWave including 28 GHz and 39 GHz. In addition, it has been considered to implement sixth-generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

According to developments of communication system, there are needs to enhance for transmitting and receiving hybrid automatic retransmission request acknowledgement information.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspects of the disclosure is to provide a method for transmitting hybrid automatic retransmission request acknowledgement (HARQ-ACK) feedback information, such as a transmission method of HARQ-ACK for a physical downlink shared channels (PDSCH).

Additional aspects will be set forth in part in the description which follows and, in part, will be apparent from the description, or may be learned by practice of the presented embodiments.

In accordance with an aspect of the disclosure, a method performed by a user equipment (UE) in a wireless communication system is provided. The method includes:
determining hybrid automatic retransmission request acknowledgement (HARQ-ACK) information,
determining transmission power of an uplink channel for transmitting the HARQ-ACK information, and
transmitting the uplink channel according to the transmission power.

In an implementation, wherein the determining transmission power of an uplink channel for transmitting the HARQ-ACK information comprises at least one of:
determining the transmission power of the uplink channel based on the HARQ-ACK information, and
determining the transmission power of the uplink channel based on a second power control parameter,
wherein the second power control parameter is independent from a first power control parameter configured by a base station, or the second power control parameter is obtained based on the first power control parameter.

In an implementation, wherein the determining the transmission power of the uplink channel based on the HARQ-ACK information comprises at least one of:
determining the transmission power of the uplink channel for transmitting the HARQ-ACK information based on a number of ACKs or NACKs in the HARQ-ACK information, and
determining the transmission power of the uplink channel for transmitting the HARQ-ACK information based on a value of the HARQ-ACK information.

In an implementation, wherein the HARQ-ACK information is determined based on at least one of:
downlink allocation indication (DAI) transmitted by the base station;
a number of semi-persistent scheduling (SPS) physical downlink shared channels (PDSCHs),
a first number of downlink channels for which feedback of HARQ-ACK is required, which is configured by higher layer signaling.

In an implementation, wherein the determining transmission power of an uplink channel for transmitting the HARQ-ACK information based on a value of the HARQ-ACK information comprises:
determining the transmission power of the uplink channel for transmitting the HARQ-ACK information based on correspondence between the value of the HARQ-ACK information and the transmission power.

In an implementation, wherein the correspondence is related to a number of downlink channels for which feedback of HARQ-ACK is required.

In an implementation, wherein the number of downlink channels for which feedback of HARQ-ACK is required is determined based on at least one of:
the DAI, the number of SPS PDSCHs, and the first number.

In an implementation, wherein the determining HARQ-ACK information comprises:
if a second number of downlink channels received by the UE is less than the first number, determining the HARQ-ACK information by appending a third number of NACKs to HARQ-ACK information for the received downlink channels, wherein the third number is equal to a difference between the first number and the second number.

In an implementation, wherein the transmission power is determined by taking the first power control parameter as the second power control parameter and setting the first power control parameter to a predetermined value.

In an implementation, wherein the predetermined value is 0.

In accordance with another aspect of the disclosure, a method performed by a base station in a wireless communication system is provided. The method includes:
transmitting a downlink channel to a user equipment (UE),
receiving an uplink channel including HARQ-ACK information for the downlink channel,
wherein the uplink channel is transmitted according to transmission power.

In an implementation, wherein:
the transmission power is determined based on the HARQ-ACK information, or
the transmission power is determined based on a second power control parameter,
wherein the second power control parameter is independent from a first power control parameter configured by the base station, or the second power control parameter is obtained based on the first power control parameter.

In an implementation, wherein the transmission power is determined based on a number of ACKs or NACKs in the HARQ-ACK information, or
the transmission power is determined based on a value of the HARQ-ACK information.

In an implementation, wherein the HARQ-ACK information is determined based on at least one of:
downlink allocation indication (DAI) transmitted by the base station,
a number of semi-persistent scheduling (SPS) physical downlink shared channels (PDSCHs),
a first number of downlink channels for which feedback of HARQ-ACK is required, which is configured by higher layer signaling.

In an implementation, wherein the transmission power is determined based on correspondence between the value of the HARQ-ACK information and the transmission power.

In an implementation, wherein the correspondence is related to a number of downlink channels for which feedback of HARQ-ACK is required.

In an implementation, wherein the number of downlink channels for which feedback of HARQ-ACK is required is determined based on at least one of:
the DAI, the number of SPS PDSCHs, and the first number.

In an implementation, wherein:
if a second number of downlink channels received by the UE is less than the first number, the HARQ-ACK information is determined by appending a third number of NACKs to HARQ-ACK information for the received downlink channels, wherein the third number is equal to a difference between the first number and the second number.

In an implementation, wherein the transmission power is determined by taking the first power control parameter as the second power control parameter and setting the first power control parameter to a predetermined value.

In an implementation, wherein the predetermined value is 0.

In accordance with another aspect of the disclosure, a user equipment (UE) in a communication system is provided. The UE includes:
a transceiver, and
a processor coupled with the transceiver and configured to:
determine hybrid automatic retransmission request acknowledgement (HARQ-ACK) information,
determine transmission power of an uplink channel for transmitting the HARQ-ACK information, and
transmit the uplink channel according to the transmission power.

In accordance with another aspect of the disclosure, a base station in a communication system is provided. The base station includes:
a transceiver, and
a processor coupled with the transceiver and configured to:
transmit a downlink channel to a user equipment (UE),
receive an uplink channel including HARQ-ACK information for the downlink channel,
wherein the uplink channel is transmitted according to transmission power.

The method of the disclosure determines the transmission power for transmitting HARQ-ACK according to the content of HARQ-ACK information, which can better ensure the reception performance when HARQ-ACK information for multiple PDSCHs is transmitted in one PUCCH by adopting NACK-only mode.

Other aspects, advantages and salient features of the disclosure will become apparent to those skilled in the art from the following detailed description, which, taken in conjunction with the annexed drawings, discloses various embodiments of this disclosure.

According to various embodiments of the disclosure, procedures regarding transmitting and receiving hybrid automatic retransmission request acknowledgement information can be efficiently enhanced.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an example of wireless network according to an embodiment of the disclosure;

FIGS. 2A and 2B illustrate examples of wireless transmission and reception paths according to various embodiments of the disclosure;

FIG. 3A shows an example UE according to an embodiment of the disclosure;

FIG. 3B shows an example gNB according to an embodiment of the disclosure;

FIG. 4 shows a flowchart of an example method according to an embodiment of the disclosure;

FIG. 5 shows a schematic diagram of a specific example for transmitting hybrid automatic retransmission request acknowledgement (HARQ-ACK) information according to an embodiment of the disclosure;

FIG. 6 shows a schematic diagram of a specific example for transmitting HARQ-ACK information according to an embodiment of the disclosure;

FIG. 7 shows a schematic flowchart of a method according to an embodiment of the disclosure;

FIG. 8 shows a schematic flowchart of a method according to an embodiment of the disclosure;

FIG. 9 shows a schematic hardware block diagram of a user equipment (UE) according to an embodiment of the disclosure; and

FIG. 10 shows a schematic hardware block diagram of a base station according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, description of well-known functions and constructions may be omitted for clarity and conciseness.

Terms and expressions used in the following specification and claims are not limited to the bibliographical meanings, but are merely used by the inventor to enable a clear and consistent understanding of the disclosure. Accordingly, it should be apparent to those skilled in the art that the following descriptions of various embodiments of the disclosure are provided for illustration purpose only and not for the purpose of limiting the disclosure as defined by the appended claims and their equivalents.

It is to be understood that singular forms of “a”, “an” and “the” include plural referents, unless the context clearly indicates otherwise. Thus, for example, references to “component surfaces” include references to one or more such surfaces.

The term “including” or “may include” refers to the existence of the corresponding disclosed functions, operations or components that can be used in various embodiments of the disclosure, rather than limiting the existence of one or more additional functions, operations or features. In addition, the term “including” or “having” can be interpreted to indicate certain features, numbers, steps, operations, constituent elements, components or combinations thereof, but should not be interpreted to exclude the possibility of the existence of one or more other features, numbers, steps, operations, constituent elements, components or combinations thereof.

The term “or” used in various embodiments of the disclosure includes any listed terms and all combinations thereof. For example, “A or B” may include A, B, or both A and B.

Unless otherwise defined, all terms (including technical terms or scientific terms) used in this disclosure have the same meanings as understood by those skilled in the art as described in this disclosure. Common terms as defined in dictionaries are interpreted to have meanings consistent with the context in relevant technical fields, and they should not be interpreted idealized or excessively formally, unless explicitly defined as such in this disclosure.

In order to make the purpose, technical solution and advantages of this application clearer, the application will be further explained in detail with reference to the attached drawings and examples.

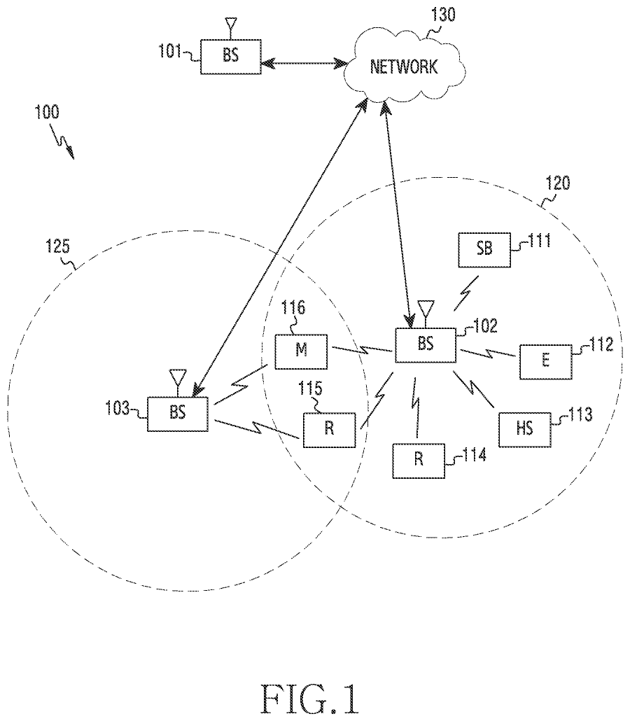

FIG. 1 illustrates an example of wireless network 100 according to an embodiment of the disclosure.

The embodiment of the wireless network 100 shown in FIG. 1 is for illustration only. Other embodiments of the wireless network 100 can be used without departing from the scope of the disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless passive data structure (PDA), etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, worldwide interoperability for microwave access (WiMAX) or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a two-dimensional (2D) antenna array as described in embodiments of the disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

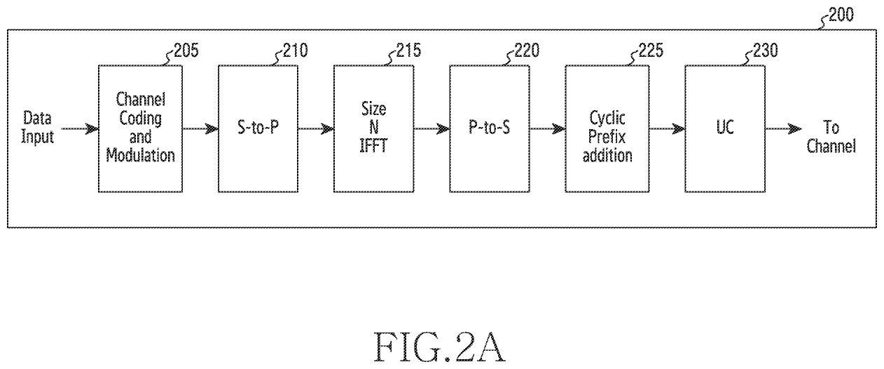

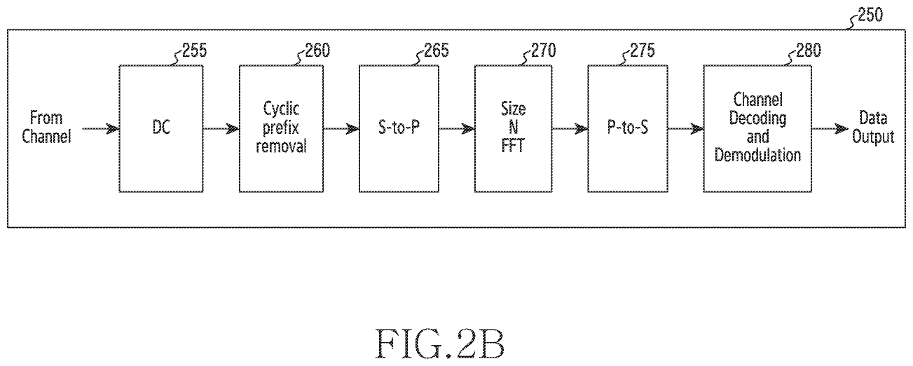

FIGS. 2A and 2B illustrate examples of wireless transmission and reception paths according to various embodiments of the disclosure.

In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

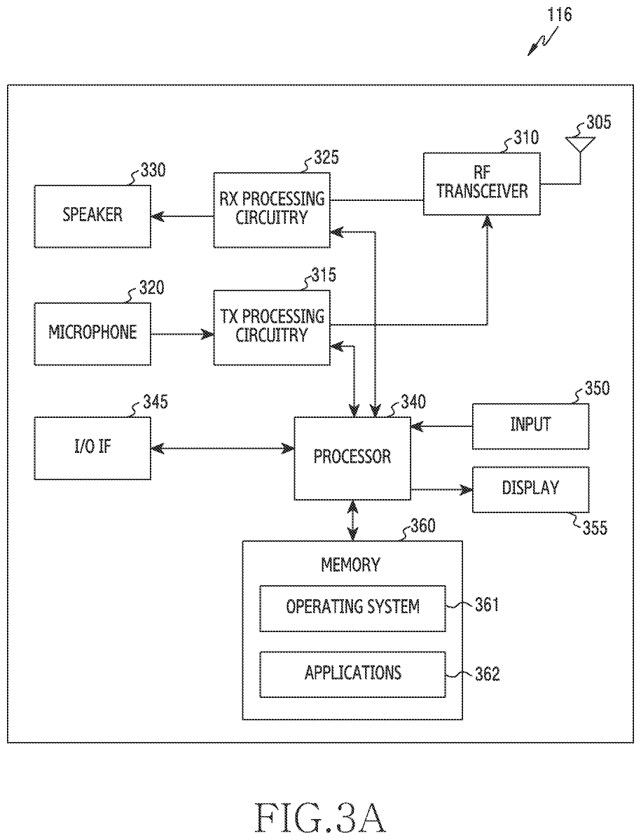

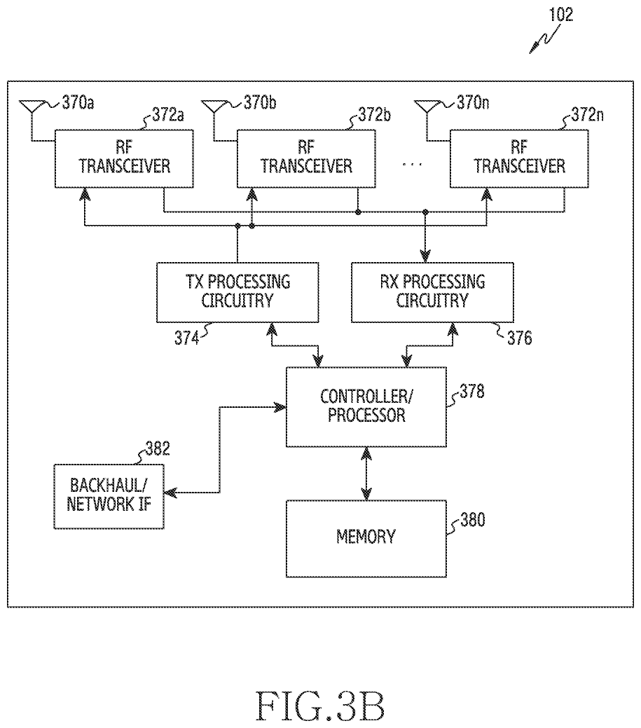

FIG. 3A illustrates an example of UE 116 according to an embodiment of the disclosure.

The embodiment of UE 116 shown in FIG. 3A is for illustration only, and UEs 111-115 of FIG. 1 can have the same or similar configuration. However, a UE has various configurations, and FIG. 3A does not limit the scope of the disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

FIG. 3B illustrates an example of gNB 102 according to an embodiment of the disclosure.

The embodiment of gNB 102 shown in FIG. 3B is for illustration only, and other gNBs of FIG. 1 can have the same or similar configuration. However, a gNB has various configurations, and FIG. 3B does not limit the scope of the disclosure to any specific implementation of a gNB. It should be noted that gNB 101 and gNB 103 can include the same or similar structures as gNB 102.

Referring to FIG. 3B, gNB 102 includes a plurality of antennas 370a, 370b . . . 370n, a plurality of RF transceivers 372a, 372b, . . . 372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3B illustrates an example of gNB 102, various changes may be made to FIG. 3B. For example, gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

The embodiments of the disclosure are further described below in conjunction with the accompanying drawings.

The text and drawings are provided as examples only to help readers understand the disclosure. They are not intended and should not be interpreted as limiting the scope of the disclosure in any way. Although certain embodiments and examples have been provided, based on the content disclosed herein, it is obvious to those skilled in the art that modifications to the illustrated embodiments and examples can be made without departing from the scope of the disclosure.

Transmission from a base station to a user equipment (UE) is called downlink, and transmission from a UE to a base station is called uplink. HARQ-ACK information for a Physical Downlink Shared Channel (PDSCH) can be transmitted in a Physical Uplink Shared Channel (PUSCH) or a physical uplink control channel (PUCCH), where the PDSCH is scheduled by Downlink Control Information (DCI) transmitted in a Physical Downlink Control Channel (PDCCH).

A unicast PDSCH is a PDSCH received by a UE, and the scrambling of the PDSCH is based on Radio Network Temporary Indicator (RNTI) specific to the UE, such as C-RNTI. (Groupcast or multicast)/broadcast is a PDSCH received by more than one UE at the same time.

There is a need to provide a technology for transmitting HARQ-ACK for (groupcast or multicast)/broadcast PDSCH.

Hereafter, the description will be made by taking the transmission of HARQ-ACK information for a PDSCH on a PUCCH as an example. However, those skilled in the art should understand that the HARQ-ACK information for a PDSCH can also be transmitted on a PUSCH or on a Physical Random Access Channel (PRACH), and the solution described later taking a PUCCH as an example is also applicable to a PUSCH and a PRACH.

If a UE transmits a PUCCH on active uplink BWP b of carrier fin primary cell c, the UE determines the PUCCH transmission power P_{PUCCH,b,f,c}(i,qᵤ,q_{d},l) in

$${P}_{PUCCH , b , f , c} ( i , {q}_{u} , {q}_{d} , l ) = min \{ \begin{matrix}{P}_{CMAX , f , c} ( i ) , \\ {P}_{O \_ PUCCH , b , f , c} ( {q}_{u} ) + 10 {log}_{10} ( {2}^{μ} \cdot {M}_{RB , b , f , c}^{PUCCH} ( i ) ) + \\ {PL}_{b , f , c} ( {q}_{d} ) + {Δ}_{F \_ PUCCH} ( F ) + {Δ}_{TF , b , f , c} ( i ) + {g}_{b , f , c} ( i , l )\end{matrix} \} \qquad Equation 1$$

PUCCH transmission occasion i as [dBm]

Among them,
P_{CMAX,f,c}(i) is the maximum output power configured for carrier f of primary cell c in PUCCH transmission occasion i.
P_{O_PUCCH,b,f,c}(q_{M}) is an open-loop power parameter. For example, it can be determined in the way specified in 3GPP TS38.213.
M_{RB,b,f,c}^{PUCCH}(i) is the transmission bandwidth of the PUCCH expressed in number of resource blocks for PUCCH transmission occasion i on activated uplink BWP b of carrier f of primary cell c. It should be noted that it is assumed here that the subcarrier spacing of BWP b is μ.
PL_{b,f,c}(q_{d}) is a parameter related to pathloss. For example, it can be determined in the way specified in 3GPP TS 38.213.
Δ_{F_PUCCH}(F) is a parameter related to a PUCCH format. For example, it can be determined in the way specified in 3GPP TS 38.213.
g_{b,f,c}(i,l) is a closed-loop power parameter. For example, it can be determined in the way specified in 3GPP TS 38.213.
Δ_{TF,b,f,c}(i) is a PUCCH transmission power adjustment parameter of the PUCCH in PUCCH transmission occasion i on active uplink BWP b of carrier f of the primary cell c.

For PUCCH format 0 and PUCCH format 1, the Δ_{TF,b,f,c}(i) can be determined in the manner specified in 3GPP TS38.213.

For PUCCH format 2, PUCCH format 3 and PUCCH format 4, and for the number of UCI bits smaller than or equal to 11, Δ_{TF,b,f,c}(i)=10 log₁₀(K₁·(n_{HARQ-ACK}(i)+O_{SR}(i)+O_{CSI}(i)/N_{RE}(i)), where K₁=6.

n_{HARQ-ACK}(i) is the number of HARQ-ACK information bits for power control, the n_{HARQ-ACK}(i) may include the number of HARQ-ACK information bits for power control of HARQ-ACK codebooks with different physical layer priorities. The number of HARQ-ACK information bits for power control of a HARQ-ACK codebook with a physical layer priority can be determined according to the configuration of the parameter pdsch-HARQ-ACK-Codebook, for example, in the manner specified in 3GPP TS38.213. For a certain physical layer priority, if the UE is not configured with the parameter pdsch-HARQ-ACK-Codebook, when there is HARQ-ACK information, the number of HARQ-ACK information bits for power control is 1, otherwise it is 0.

O_{SR}(i) is the number of SR information bits and/or LRR information bits, the O_{SR}(i) may include the number of SR information bits and/or LRR information bits with different physical layer priorities. Or the O_{SR}(i) may be the number of SR information bits and/or LRR information bits with a certain physical layer priority. For example, the number of SR information bits and/or LRR information bits with a physical layer priority can be determined according to the way specified by 3GPP TS 38.213 9.2.5.1.

O_{SR}(i) is the number of CSI information bits, and the O_{CSI}(i) may contain the number of CSI information bits with different physical layer priorities. For example, the number of CSI information bits with a physical layer priority can be determined according to the way specified by 3GPP TS 38.213 9.2.5.2.

N_{RE}(i) is the number of REs for transmitting UCI. N_{RE}(i)=M_{RB,b,f,c}^{PUCCH}(i)·N_{sc,ctrl}^{RB}(i)·N_{symb-UCI,b,f,c}^{PUCCH}(i), where N_{sc,ctrl}^{RB}(i) is the number of subcarriers per RB excluding subcarriers used for DMRS, and N_{symb-UCI,b,f,c}^{PUCCH}(i) is the number of OFDM symbols excluding OFDM symbols used for DMRS.

For PUCCH format 2, PUCCH format 3 and PUCCH format 4, and for the number of UCI bits greater than 11, Δ_{TF,b,f,c}(i)=10 log₁₀(2^{K}^{₂}^{·BPRE(i)}−1), where

K₂=2.4, Equation 2

BPRE(i)=(O_{ACK}(i)+O_{SR}(i)+O_{CSI}(i)+O_{CRC}(i))/N_{RE}(i). Equation 3

O_{ACK}(i) is the number of information bits of a HARQ-ACK codebook, the O_{ACK}(i) may include the number of information bits of HARQ-ACK codebooks with different physical layer priorities. The number of information bits of a HARQ-ACK codebook with a physical layer priority can be determined according to the parameter configuration of pdsch-HARQ-ACK-Codebook, for example, as specified in 3GPP TS38.213. For a certain physical layer priority, if the UE is not configured with the parameter pdsch-HARQ-ACK-Codebook, when there is HARQ-ACK information, the number of HARQ-ACK information bits for power control is 1, otherwise it is 0.

O_{SR}(i) is the number of SR information bits and/or LRR information bits, the O_{SR}(i) may include the number of SR information bits and/or LRR information bits with different physical layer priorities. Or the O_{SR}(i) may be the number of SR information bits and/or LRR information bits with a certain physical layer priority. For example, the number of SR information bits and/or LRR information bits with a physical layer priority can be determined according to the way specified in 3GPP TS 38.213 9.2.5.1.

O_{CSI}(i) is the number of CSI information bits, the O_{CSI}(i) may contain the number of CSI information bits with different physical layer priorities. For example, the number of SR information bits and/or LRR information bits with a physical layer priority can be determined according to the way specified in 3GPP TS 38.213 9.2.5.2.

O_{CRC}(i) is the number of CRC bits, the O_{CRC}(i) may contain the number of CRC bits with different physical layer priorities.

N_{RE}(i) is the number of REs for transmitting UCI. N_{RE}(i)=M_{RB,b,f,c}^{PUCCH}(i)·N_{sc,ctrl}^{RB}(i)·N_{symb-UCI,b,f,c}^{PUCCH}(i), where N_{sc,ctrl}^{RB}(i) is the number of subcarriers per RB excluding subcarriers used for DMRS, and N_{symb-UCI,b,f,c}^{PUCCH}(i) is the number of OFDM symbols excluding OFDM symbols used for DMRS.

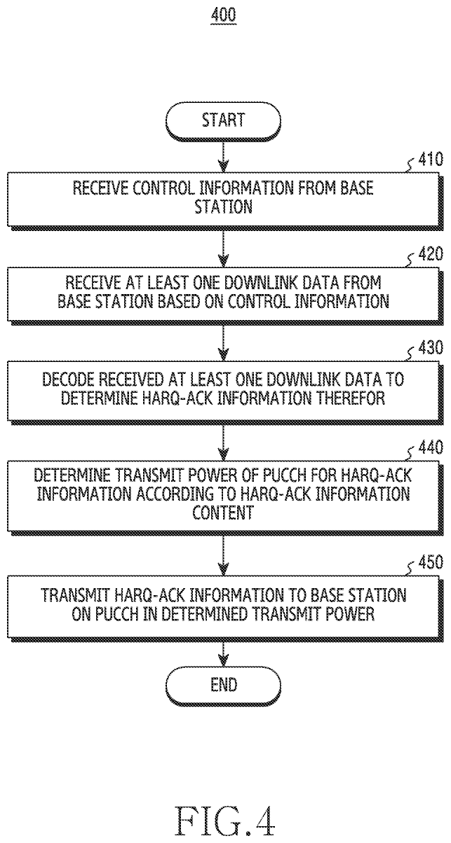

FIG. 4 shows a flowchart of an example method 400 according to an embodiment of the disclosure.

The example method 400 of FIG. 4 may be used to transmit hybrid automatic retransmission request acknowledgement (HARQ-ACK) information. The method 400 can be implemented at the UE side.

Referring to FIG. 4, in operation 410 of the method 400, receive control information from the base station. For example, the control information may be downlink control information (DCI).

At operation 420, receive at least one downlink data based on the control information. For example, the downlink data may be a PDSCH.

At operation 430, decode the received at least one downlink data to determine the HARQ-ACK information for the at least one downlink data.

At operation 440, determine the transmission power of the HARQ-ACK information on a PUCCH according to the content of the HARQ-ACK information.

At operation 450, the HARQ-ACK information is transmitted to the base station on the PUCCH according to the determined power.

As the downlink data, the PDSCH can be a multicast PDSCH or a broadcast PDSCH, that is, the same PDSCH can be received by more than one UE.

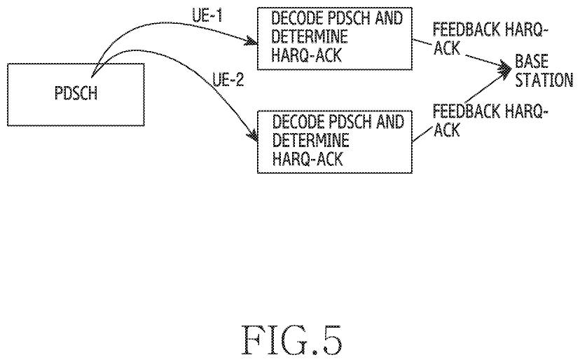

FIG. 5 shows a schematic diagram of a specific example for transmitting hybrid automatic retransmission request acknowledgement (HARQ-ACK) information according to an embodiment of the disclosure.

Referring to FIG. 5, two UEs, UE-1 and UE-2, receive the same PDSCH, respectively determine the HARQ-ACK information according to the correctness of their respective decoding of the PDSCH, and respectively feedback their respective HARQ-ACK information to the base station. However, the PDSCH is not limited to multicast PDSCH and broadcast PDSCH.

According to an embodiment of the disclosure, the transmission mode of HARQ-ACK may be: if the UE correctly decodes a PDSCH, the UE does not feedback HARQ-ACK information, but if the UE receives a PDCCH but does not correctly decode the PDSCH, the UE feeds back a NACK on PUCCH resources. This mode of HARQ-ACK transmission mode is called NACK-only mode. The following describes PUCCH power control when transmitting HARQ-ACK using NACK-only mode, and this power control method can also be used for PUCCH power control when transmitting HARQ-ACK using ACK/NACK mode.

What is described as the above is the processing method when the UE needs to feedback the HARQ-ACK information for one or more PDSCHs in one slot.

According to the embodiment of the disclosure, the UE and at least one other UE can use the same resource or resource pair to transmit the HARQ-ACK information for the same downlink data.

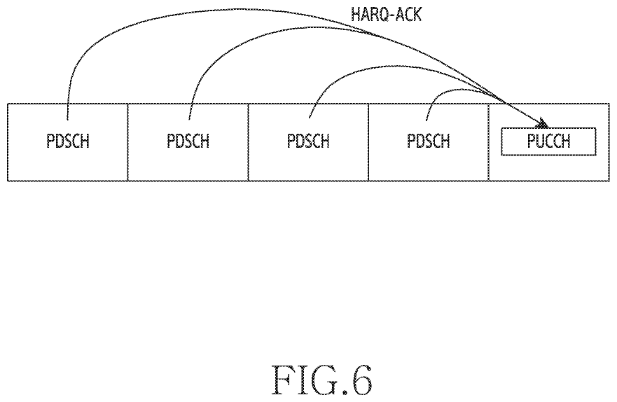

FIG. 6 shows a schematic diagram of a specific example for transmitting hybrid automatic retransmission request acknowledgement (HARQ-ACK) information according to an embodiment of the disclosure.

When the UE is to feedback HARQ-ACK information for more than one PDSCH in one slot, an embodiment of its processing method will be explained below with reference to FIG. 6.

### Embodiment 1

When the UE receives one or more PDSCHs, the UE selects a PUCCH resource of a group of PUCCH resources (it can also select a signal sequence from a plurality of signal sequences in a PUCCH resource; while the methods described below take selecting a PUCCH resource from a group of PUCCH resources as an example for illustration, these methods can also be applied to the case of selecting a signal sequence from a plurality of signal sequences in a PUCCH resource) according to HARQ-ACK information for the one or more PDSCHs, to transmit the HARQ-ACK information for the one or more PDSCHs. For example, when it is required to transmit HARQ-ACK information for L=3 PDSCHs, an method for determining the HARQ-ACK information is shown in Table 1. Table 1 is merely an example of mapping HARQ-ACK information for PDSCHs and PUCCH resources for transmitting HARQ-ACK information using NACK-only, and does not exclude other methods for mapping HARQ-ACK information for PDSCHs and PUCCH resources.

Table 1: correspondence between HARQ-ACK information for PDSCHs and PUCCH resources for feedback of HARQ-ACK

TABLE 1

| HARQ-ACK | HARQ-ACK | HARQ-ACK | PUCCH |
|---|---|---|---|
| information | information | information | resource for |
| for the first | for the second | for the third | feedback of |
| PDSCH | PDSCH | PDSCH | HARQ-ACK |
| NACK | ACK | ACK | PUCCH-1 |
| NACK | NACK | ACK | PUCCH-2 |
| ACK | NACK | ACK | PUCCH-3 |
| NACK | ACK | NACK | PUCCH-4 |
| NACK | NACK | NACK | PUCCH-5 |
| ACK | NACK | NACK | PUCCH-6 |
| ACK | ACK | NACK | PUCCH-7 |
| ACK | ACK | ACK | No transmission |

The following describes the power control method of the PUCCH for transmitting HARQ-ACK when transmitting HARQ-ACK according to the above method.

Power control of PUCCH:

When the UE is configured to feedback the HARQ-ACK information in

$${P}_{PUCCH , b , f , c} ( i , {q}_{u} , {q}_{d} , l ) = min \{ \begin{matrix}{P}_{CMAX , f , c} ( i ) , \\ {P}_{O \_ PUCCH , b , f , c} ( {q}_{u} ) + 10 {log}_{10} ( {2}^{μ} \cdot {M}_{RB , b , f , c}^{PUCCH} ( i ) ) + \\ {PL}_{b , f , c} ( {q}_{d} ) + {Δ}_{F \_ PUCCH} ( F ) + {Δ}_{TF , b , f , c} ( i ) + {g}_{b , f , c} ( i , l )\end{matrix} \}$$

NACK-only transmission mode, in an implementation, a term related to the HARQ-ACK information can be modified and/or added in the above formula. For example, the term related to the HARQ-ACK information can be a newly added term or a term obtained by modifying Δ_{TF,b,f,c}(i) term or Δ_{F_PUCCH}(F) term.

The following describes the power control of PUCCH by taking the modification of Δ_{TF,b,f,c}(i) term as an example. This method can also be applicable to modification of Δ_{F_PUCCH}(F) term or a newly added term.

In an implementation, the modified Δ_{TF,b,f,c}(i) term and the HARQ-ACK information to be transmitted by the UE satisfy the following relationship:

Δ_{TF,b,f,c}(i)=f(HARQ−ACK) Equation 4

What is described in the above formula is that Δ_{TF,b,f,c}(i) is the function of HARQ-ACK information, that is, the value of Δ_{TF,b,f,c}(i) is determined by the value of HARQ-ACK information transmitted by the PUCCH.

In an implementation, there is correspondence between Δ_{TF,b,f,c}(i) and HARQ-ACK information. For example, in the case where the number of PDSCHs L=3, the correspondence is, for example, as shown in Table 2. It should be understood that Table 2 is only an example of the correspondence between Δ_{TF,b,f,c}(i) and HARQ-ACK information. In an implementation, when the number L of PDSCHs is other value, there are other correspondences between Δ_{TF,b,f,c}(i) and HARQ-ACK information.

Table 2: Correspondence between HARQ-ACK information value for PDSCH and Δ_{TF,b,f,c}(i) of PUCCH for feedback of HARQ-ACK

TABLE 2

| HARQ-ACK | HARQ-ACK | HARQ-ACK | PUCCH | |
|---|---|---|---|---|
| information | information | information | resource for | |
| for the first | for the second | for the third | feedback of | |
| PDSCH | PDSCH | PDSCH | HARQ-ACK | Δ_{TF, b, f, c}(i) |
| NACK | ACK | ACK | PUCCH-1 | Δ_1 |
| NACK | NACK | ACK | PUCCH-2 | Δ_2 |
| ACK | NACK | ACK | PUCCH-3 | Δ_3 |
| NACK | ACK | NACK | PUCCH-4 | Δ_4 |
| NACK | NACK | NACK | PUCCH-5 | Δ_5 |
| ACK | NACK | NACK | PUCCH-6 | Δ_6 |
| ACK | ACK | NACK | PUCCH-7 | Δ_7 |
| ACK | ACK | ACK | No | |
| | | | transmission | |

In an implementation, the method for determining Δ_{TF,b,f,c}(i) is as follows:

Δ_{TF,b,f,c}(i)=α·the number of NACKs in HARQ−ACK information

That is, Δ_{TF,b,f,c}(i) is a multiple a of the number of NACKs in the HARQ-ACK information, the multiple a can be preset, configured by the base station, or selected or set by the UE itself. In an implementation, the multiple a may be a value greater than or less than 1.

For example, when HARQ-ACK information for only one PDSCH is NACK as shown in the following table 2-1, Δ_{TF,b,f,c}(i)=α

TABLE 2-1
Table 2-1: HARQ-ACK information
for only one PDSCH is NACK

| HARQ-ACK | HARQ-ACK | HARQ-ACK | PUCCH | |
|---|---|---|---|---|
| information | information | information | resource for | |
| for the first | for the second | for the third | feedback of | |
| PDSCH | PDSCH | PDSCH | HARQ-ACK | Δ_{TF, b, f, c}(i) |
| NACK | ACK | ACK | PUCCH-1 | α |
| ACK | NACK | ACK | PUCCH-3 | α |
| ACK | ACK | NACK | PUCCH-7 | α |

For example, when HARQ-ACK information for two PDSCHs is NACK as shown in the following table 2-2, Δ_{TF,b,f,c}(i)=2·α

TABLE 2-2
Table 2-2: HARQ-ACK information for two PDSCHs is NACK

| HARQ-ACK | HARQ-ACK | HARQ-ACK | PUCCH | |
|---|---|---|---|---|
| information | information | information | resource for | |
| for the first | for the second | for the third | feedback of | |
| PDSCH | PDSCH | PDSCH | HARQ-ACK | Δ_{TF, b, f, c}(i) |
| NACK | NACK | ACK | PUCCH-2 | 2 · α |
| NACK | ACK | NACK | PUCCH-4 | 2 · α |
| ACK | NACK | NACK | PUCCH-6 | 2 · α |

For example, when HARQ-ACK information for the three PDSCHs is NACK as shown in following Table 2-3, Δ_{TF,b,f,c}(i)=3·α

TABLE 2-3
Table 2-3: HARQ-ACK information for three PDSCHs is NACK

| HARQ-ACK | HARQ-ACK | HARQ-ACK | PUCCH | |
|---|---|---|---|---|
| information | information | information | resource for | |
| for the first | for the second | for the third | feedback of | |
| PDSCH | PDSCH | PDSCH | HARQ-ACK | Δ_{TF, b, f, c}(i) |
| NACK | NACK | NACK | PUCCH-5 | 3 · α |

For the HARQ-ACK transmission mode of NACK-only, the NACK information helps the base station to determine the reception of a PDSCH transmitted by the base station at the UE, so that the base station knows that some UEs have not received correctly, and the base station needs to retransmit the PDSCH. Moreover, the NACK information is useful information, and the performance of receiving the NACK information transmitted by the UE by the base station can be better ensured by adopting the above power control method.

Some examples of setting Δ_{TF,b,f,c}(i) as a function of HARQ-ACK information have been described above, and the correspondence between the value of Δ_{TF,b,f,c}(i) and HARQ-ACK information has been illustrated with the example case where the number of PDSCH L=3 shown in Table 2.

According to the embodiment of the disclosure, the number L of PDSCHs related to determining the value of Δ_{TF,b,f,c}(i) (that is, the number of PDSCHs for which HARQ-ACK is to be transmitted) can be determined in the following two ways.

The first way is: the number of PDSCHs for which HARQ-ACK is to be transmitted is determined by the Downlink Assignment Indication (DAI) in the received DCI and/or the number of semi-persistent scheduling (SPS) PDSCHs, and then the power of PUCCH for transmitting HARQ-ACK is determined according to the HARQ-ACK value for the determined number of PDSCHs. For example, the UE receives DCI of two scheduled PDSCHs, the HARQ-ACKs for these two PDSCHs are transmitted in one PUCCH, the DAI in the DCI of the first scheduled PDSCH is equal to 1, the HARQ-ACK value for the first scheduled PDSCH is ‘NACK’, the DAI in the DCI of the second scheduled PDSCH is equal to 2, and the HARQ-ACK value for the second scheduled PDSCH is ‘ACK’, then the UE determines the power of the PUCCH according to the HARQ-ACK value {NACK, ACK} for these two PDSCHs. The advantage of this method is that it can save the power consumption for UE transmitting a PUCCH as much as possible.

The second way is: the number of PDSCHs for which HARQ-ACK is to be transmitted is determined to be L by the received signaling configuration (e.g., higher layer signaling configuration). When the number Q of PDSCHs determined by the UE according to the Downlink Assignment Indication (DAI) in the DCI of the scheduled PDSCH received is less than the number L of PDSCHs configured by higher layer signaling, L-Q NACKs can be appended to the tail (or front, or other predetermined positions) of the HARQ-ACK information for the Q scheduled PDSCHs, so that the power of PUCCH can be determined according to the HARQ-ACK information corresponding to L and based on the correspondence associated with the number L.

For example, the UE receives signaling configuration (e.g., higher layer signaling configuration) to determine that the number L of PDSCHs for which HARQ-ACK is to be transmitted is 3, and the UE receives DCI of two scheduled PDSCHs, the HARQ-ACK for these two PDSCHs is transmitted in one PUCCH, the DAI in the DCI of the first scheduled PDSCH is equal to 1, and the DAI in the DCI of the second scheduled PDSCH is equal to 2. The UE appends a NACK to the HARQ-ACK for the first scheduled PDSCH and the second scheduled PDSCH, and determines the power of PUCCH for feedback of HARQ-ACK according to the HARQ-ACK information content after appending the NACK to the HARQ-ACK for the first scheduled PDSCH and the second scheduled PDSCH. For example, the HARQ-ACK for the first scheduled PDSCH is ACK, and the HARQ-ACK for the second scheduled PDSCH is NACK. The UE determines the power of the PUCCH for feedback of the HARQ-ACK according to the information of {ACK, NACK, NACK}. The advantage of this method is that if the last PDSCH is missed by the UE, the UE can also guarantee the performance of HARQ-ACK information feedback.

It should be understood that in the above description of the two modes, it is assumed that the number of SPS PDSCH is 0. It can be understood that when the number of SPS PDSCH is not zero, the number of SPS PDSCHs and the HARQ-ACK information for SPS PDSCHs should also be taken into consideration.

For example, in the first way, if the UE receives DCI of two scheduled PDSCH, and the UE determines that there is one SPS PDSCH, the UE determines that the number of PDSCHs for which HARQ-ACK information is to be transmitted is 3. If the HARQ-ACKs for these three PDSCHs are to be transmitted in one PUCCH, the UE determines the power of the PUCCH according to the HARQ-ACKs for these three PDSCHs (for example, based on the correspondence associated with the number 3 of PDSCHs).

For example, in the second way, if the UE receives signaling configuration (e.g., higher layer signaling configuration) and determines that the number L of PDSCHs for which HARQ-ACK is to be transmitted is 4, and the UE receives DCI of two scheduled PDSCHs, and determines that the number of SPS PDSCH is 1. If the HARQ-ACKs for these three PDSCHs are to be transmitted in one PUCCH, the UE appends a NACK to the tail (or front, or other predetermined positions) of the HARQ-ACKs for the two scheduled PDSCHs and the one SPS PDSCH, so as to obtain the HARQ-ACK information to be fed back, and determines the power of the PUCCH for feedback of the HARQ-ACKs according to the HARQ-ACK information to be fed back. For example, if the HARQ-ACK for the first scheduled PDSCH is ACK, the HARQ-ACK for the second scheduled PDSCH is NACK, and the HARQ-ACK for the SPS PDSCH is ACK, then the UE determines the power of the PUCCH for feedback of the HARQ-ACK according to the HARQ-ACK information as {ACK, NACK, ACK, NACK}. It should be understood that the HARQ-ACK for the SPS PDSCH does not have to be placed after the scheduled PDSCH, but may also be in other predefined positions.

### Embodiment 2

The power control of PUCCH can be based on the following formula:

$${P}_{PUCCH , b , f , c} ( i , {q}_{u} , {q}_{d} , l ) = min \{ \begin{matrix}{P}_{CMAX , f , c} ( i ) , \\ {P}_{O \_ PUCCH , b , f , c} ( {q}_{u} ) + 10 {log}_{10} ( {2}^{μ} \cdot {M}_{RB , b , f , c}^{PUCCH} ( i ) ) + \\ {PL}_{b , f , c} ( {q}_{d} ) + {Δ}_{F \_ PUCCH} ( F ) + {Δ}_{TF , b , f , c} ( i ) + {g}_{b , f , c} ( i , l )\end{matrix} \}$$

The P_{O_PUCCH,b,f,c}(qᵤ) is an open-loop power control parameter, which is the sum of two parts: P_{O_PUCCH,b,f,c}(qᵤ)=P_{O_NOMINAL_PUCCH}+P_{O_UE_PUCCH}, where one part P_{O_NOMINAL_PUCCH} is an open-loop power control parameter common to the cell, and the other part P_{O_UE_PUCCH} is an open-loop power control parameter specific to the UE.

For the case where the UE feeds back the HARQ-ACK for a UE-specific PDSCH (for example, a unicast PDSCH, a PDSCH scheduled by a PDCCH with CRC scrambled by C-RNTI, or a PDSCH scheduled by DCI format 1_0 or 1_1), the performance requirements of HARQ-ACK feedback may be different for different UEs, so the configured P_{O_UE_PUCCH} may be different for different UEs. While for a broadcast/multicast PDSCH (a broadcast/multicast PDSCH and a unicast PDSCH can be distinguished by the format of DCI in the PDCCH scheduling the PDSCH and/or RNTI scrambling CRC of the PDCCH; for example, RNTI scrambling CRC for the PDCCH scheduling a broadcast/multicast PDSCH is G-RNTI, and RNTI scrambling CRC for the PDCCH scheduling a unicast PDSCH is C-RNTI), the performance requirements of HARQ-ACK feedback of UEs within a broadcast/multicast group may be the same. One realizable method is to configure, for the PUCCH for the UE in a group receiving broadcast/multicast to feedback HARQ-ACK for a broadcast/multicast PDSCH, a power control parameter P_{O_UE_PUCCH} independent from that used to feedback HARQ-ACK for UE-specific PDSCH. For example, for a PUCCH where the UE feeds back HARQ-ACK for a broadcast/multicast PDSCH, a power control parameter P_{O_UE_PUCCH_1} can be configured; for a PUCCH where the UE feeds back HARQ-ACK for a UE-specific PDSCH, a power control parameter P_{O_UE_PUCCH_2} can be configured. That is, the base station or other network nodes can configure the UE with a power control parameter P_{O_UE_PUCCH_1} for feedback of HARQ-ACK for a UE-specific PDSCH and a power control parameter P_{O_UE_PUCCH_2} for feedback of HARQ-ACK for a multicast or broadcast PDSCH respectively. For example, for a PDSCH scheduled by a new DCI format x_1 or x_0 (e.g., DCI format 4_1 or 4_0) or a PDSCH scheduled by a PDCCH with CRC scrambled with G-RNTI, the base station can configure a power control parameter P_{O_UE_PUCCH_1} for the UE to transmit HARQ-ACK for this type of PDSCH, while for a PDSCH scheduled by a PDCCH with CRC scrambled with C-RNTI, or a PDSCH scheduled in DCI format 1_0 or 1_1, the base station can configure a power control parameter P_{O_UE_PUCCH_2} for the UE to transmit HARQ-ACK for this type of PDSCH.

Another realizable method is that it is not separately configured, for the PUCCH for the UE in a group receiving broadcast/multicast to feedback HARQ-ACK for a broadcast/multicast PDSCH, a power control parameter P_{O_UE_PUCCH} independent from that used to feedback HARQ-ACK for UE-specific PDSCH. In an implementation, the UE is only configured with a power control parameter P_{O_UE_PUCCH} for feedback of HARQ-ACK for a UE-specific PDSCH. When the UE receives a broadcast/multicast PDSCH, the UE in the broadcast/multicast related group determines the power of PUCCH for feedback of HARQ-ACK for a broadcast/multicast PDSCH by setting the power control parameter configured for the UE for feedback of HARQ-ACK for a UE-specific PDSCH to a predetermined value. In an implementation, in the case of a broadcast/multicast PDSCH, P_{O_UE_PUCCH} can be set to 0, and only P_{O_NOMINAL_PUCCH} is used for power control of the PUCCH for feedback of HARQ-ACK for a broadcast/multicast PDSCH.

The above method can ensure that the performance requirements of HARQ-ACK feedback of UEs in a broadcast/multicast group should be the same.

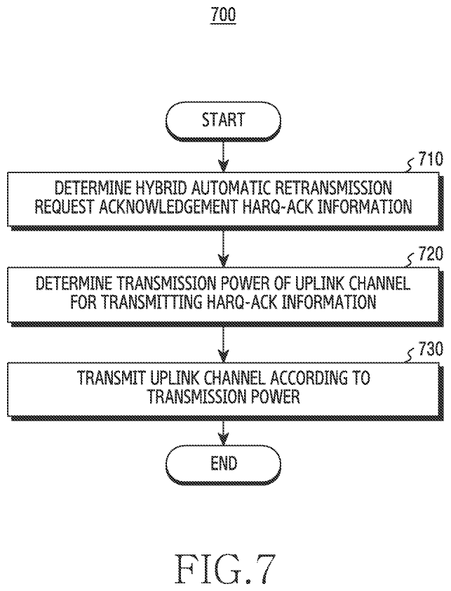

FIG. 7 shows a schematic flowchart of a method 700 according to an embodiment of the disclosure.

Referring to FIG. 7, the method 700 includes the following operations:
Operation 710: determine hybrid automatic retransmission request acknowledgement (HARQ-ACK) information;
Operation 720: determine transmission power of an uplink channel for transmitting the HARQ-ACK information; and
Operation 730: transmit the uplink channel according to the transmission power.

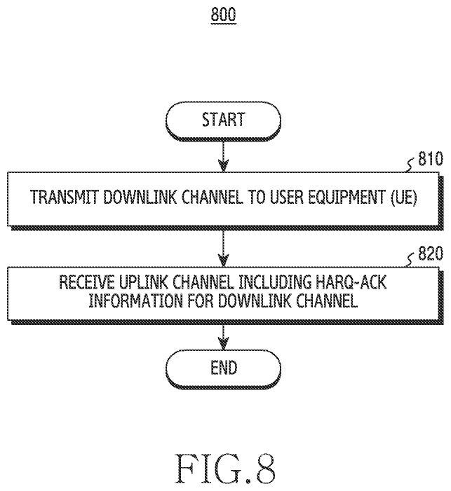

FIG. 8 shows a schematic flowchart of a method 800 according to an embodiment of the disclosure.

Referring to FIG. 8, the method 800 includes the following operations:
Operation 810: transmit a downlink channel to the user equipment (UE);
Operation 820: receive an uplink channel including HARQ-ACK information for the downlink channel,
wherein, the uplink channel is transmitted according to the transmission power.

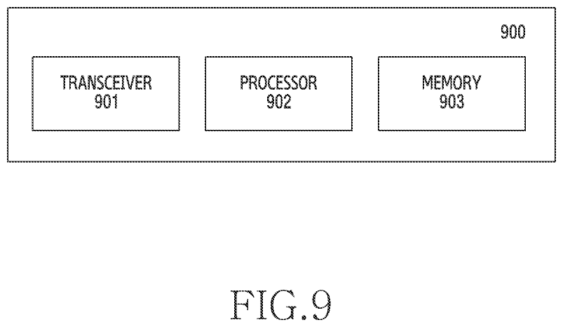

FIG. 9 shows a block diagram of an example UE with a processor according to an embodiment of the disclosure.

Referring to FIG. 9, the UE 900 includes a transceiver 901, a processor 902 and a memory 903. Under the control of the controller 902 (which can be implemented as one or more processors), the UE 900 can be configured to perform related operations performed by the UE in the above-described methods. Although the transceiver 901, the processor 902 and the memory 903 are shown as separate entities, they can be implemented as a single entity, such as a single chip. Transceiver 901, processor 902 and memory 903 may be electrically connected or coupled to each other. Transceiver 901 may transmit and receive signals to and from other network entities, such as nodes (which may be, for example, base stations, relay nodes, etc.) and/or another UE. In some implementations, the transceiver 901 may be omitted. In this case, the processor 902 may be configured to execute the instructions (including computer programs) stored in the memory 903 to control the overall operation of the UE 900, thereby realizing the operations in the flow of the above methods. Furthermore, the UE 900 of FIG. 9 corresponds to the UE of the FIG. 3A.

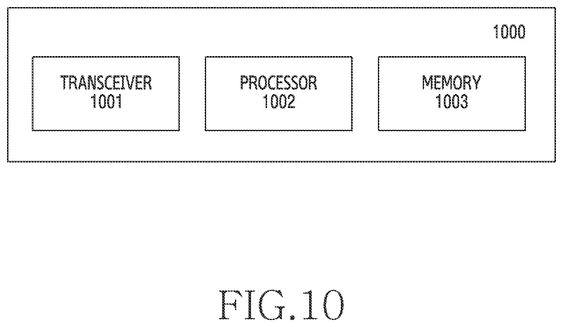

FIG. 10 shows a block diagram of an example base station according to an embodiment of the disclosure.

Referring to FIG. 10, the base station 1000 includes a transceiver 1001, a processor 1002 and a memory 1003. Under the control of the processor 1002 (which can be implemented as one or more processors), the base station 1000 can be configured to perform the related operations performed by the base station in the above-described methods. Although the transceiver 1001, the processor 1002 and the memory 1003 are shown as separate entities, they can be implemented as a single entity, such as a single chip. Transceiver 1001, processor 1002 and memory 1003 may be electrically connected or coupled to each other. Transceiver 1001 may transmit and receive signals to and from other network entities, such as another node (which may be, for example, a base station, a relay node, etc.) and/or a UE. In some embodiments, the transceiver 1001 may be omitted. In this case, the processor 1002 may be configured to execute the instructions (including computer programs) stored in the memory 1003 to control the overall operation of the base station 1000, thereby realizing the operations in the flow of the above methods. Furthermore, the UE 900 of FIG. 9 corresponds to the gNB of the FIG. 3B.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) in a wireless communication system, the method comprising:
determining hybrid automatic retransmission request acknowledgement (HARQ-ACK) information;
determining transmission power of an uplink channel for transmitting the HARQ-ACK information; and
transmitting the uplink channel according to the transmission power.

2. The method of claim 1, wherein the determining of the transmission power of the uplink channel for transmitting the HARQ-ACK information comprises at least one of:
determining the transmission power of the uplink channel based on the HARQ-ACK information; and
determining the transmission power of the uplink channel based on a second power control parameter,
wherein the second power control parameter is independent from a first power control parameter configured by a base station, or the second power control parameter is obtained based on the first power control parameter.

3. The method of claim 2, wherein the determining of the transmission power of the uplink channel based on the HARQ-ACK information comprises at least one of:
determining the transmission power of the uplink channel for transmitting the HARQ-ACK information based on a number of ACKs or NACKs in the HARQ-ACK information; and
determining the transmission power of the uplink channel for transmitting the HARQ-ACK information based on a value of the HARQ-ACK information.

4. The method of claim 3, wherein the HARQ-ACK information is determined based on at least one of:
downlink allocation indication (DAI) transmitted by the base station;
a number of semi-persistent scheduling (SPS) physical downlink shared channels (PDSCHs); and
a first number of downlink channels for which feedback of HARQ-ACK is required configured by higher layer signaling.

5. The method of claim 4, wherein the determining of the transmission power of the uplink channel for transmitting the HARQ-ACK information based on a value of the HARQ-ACK information comprises determining the transmission power of the uplink channel for transmitting the HARQ-ACK information based on correspondence between the value of the HARQ-ACK information and the transmission power.

6. The method of claim 5, wherein the correspondence is related to a number of downlink channels for which feedback of HARQ-ACK is required.

7. The method of claim 6, wherein the number of downlink channels for which feedback of HARQ-ACK is required is determined based on at least one of the DAI, the number of SPS PDSCHs, or the first number.

8. The method of claim 4,
wherein the determining of the HARQ-ACK information comprises, in case that a second number of downlink channels received by the UE is less than the first number, determining the HARQ-ACK information by appending a third number of NACKs to HARQ-ACK information for the received downlink channels, and
wherein the third number is equal to a difference between the first number and the second number.

9. The method of claim 2,
wherein the transmission power is determined by taking the first power control parameter as the second power control parameter and setting the first power control parameter to a predetermined value, and
wherein the predetermined value is 0.

10. A method performed by a base station in a wireless communication system, the method comprising:
transmitting a downlink channel to a user equipment (UE); and
receiving an uplink channel including hybrid automatic retransmission request acknowledgement (HARQ-ACK) information for the downlink channel,
wherein the uplink channel is transmitted according to transmission power.

11. The method of claim 10,
wherein the transmission power is determined based on the HARQ-ACK information or the transmission power is determined based on a second power control parameter, and
wherein the second power control parameter is independent from a first power control parameter configured by the base station, or the second power control parameter is obtained based on the first power control parameter.

12. The method of claim 11, wherein the transmission power is determined based on a number of ACKs or NACKs in the HARQ-ACK information, or the transmission power is determined based on a value of the HARQ-ACK information.

13. The method of claim 12, wherein the HARQ-ACK information is determined based on at least one of:
downlink allocation indication (DAI) transmitted by the base station;
a number of semi-persistent scheduling (SPS) physical downlink shared channels (PDSCHs); or
a first number of downlink channels for which feedback of HARQ-ACK is required, which is configured by higher layer signaling.

14. The method of claim 13, wherein the transmission power is determined based on correspondence between the value of the HARQ-ACK information and the transmission power.

15. The method of claim 14, wherein the correspondence is related to a number of downlink channels for which feedback of HARQ-ACK is required.

16. The method of claim 15, wherein the number of downlink channels for which feedback of HARQ-ACK is required is determined based on at least one of the DAI, the number of SPS PDSCHs, or the first number.

17. The method of claim 13,
wherein in case that a second number of downlink channels received by the UE is less than the first number, the HARQ-ACK information is determined by appending a third number of NACKs to HARQ-ACK information for the received downlink channels, and
wherein the third number is equal to a difference between the first number and the second number.

18. The method of claim 11,
wherein the transmission power is determined by taking the first power control parameter as the second power control parameter and setting the first power control parameter to a predetermined value, and
wherein the predetermined value is 0.

19. A user equipment (UE) in a wireless communication system, the UE comprising:
a transceiver; and
a controller coupled with the transceiver and configured to:
determine hybrid automatic retransmission request acknowledgement (HARQ-ACK) information,
determine transmission power of an uplink channel for transmitting the HARQ-ACK information, and
control the transceiver to transmit the uplink channel according to the transmission power.

20. A base station in a wireless communication system, the base station comprising:
a transceiver; and
a controller coupled with the transceiver and configured to:
transmit a downlink channel to a user equipment (UE), and
receive an uplink channel including hybrid automatic retransmission request acknowledgement (HARQ-ACK) information for the downlink channel,
wherein the uplink channel is transmitted according to a transmission power determined by the UE.
